(19) United States
(12) Patent Application Publication
(10) Pub. No.: US 2021/0097493 A1
(43) Pub. Date: Apr. 1, 2021

(54) RESPONSE RATE PREDICTION

(71) Applicant: Microsoft Technology Licensing, LLC, Redmond, WA (US)

(72) Inventors: Fenglin Li, Santa Clara, CA (US); Qing Duan, Santa Clara, CA (US); Aditya S. Aiyer, San Jose, CA (US); Kun Tian, Sunnyvale, CA (US)

(73) Assignee: Microsoft Technology Licensing, LLC, Redmond, WA (US)

(21) Appl. No.: 16/588,663

(22) Filed: Sep. 30, 2019

(51) Int. Cl. G06Q 10/10; G06N 20/00

(52) U.S. Cl. CPC G06Q 10/1053; G06N 20/00

(57) ABSTRACT

The disclosed embodiments provide a system for predicting response rates. During operation, the system determines features representing historical applications to opportunities and historical responses to the historical applications by a poster of the opportunities, wherein the historical responses include interactions between the poster and candidates submitting the historical applications and notifications transmitted to the candidates of actions related to the historical applications by the poster. Next, the system applies one or more operations to the features to generate a predicted response rate of the poster to an application for an opportunity by a member of the online system. The system then compares the predicted response rate to a threshold to determine a recommendation related to the application by the member. Finally, the system outputs, to the member in a user interface of the online system, the recommendation in association with the opportunity.

### BACKGROUND

### Field

The disclosed embodiments relate to techniques for predicting response rates.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be implemented and/or maintained on web-based networking services, such as client-server applications and/or devices that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals use an online network to locate prospects, maintain a professional image, establish and maintain relationships, and/or engage with other individuals and organizations. Similarly, recruiters use the online network to search for candidates for job opportunities and/or open positions. At the same time, job seekers use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for predicting response rates in accordance with the disclosed embodiments.

FIG. 3 shows a flowchart illustrating a process of predicting response rates in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing content and/or user interfaces in online systems. For example, the content includes jobs and/or other opportunities that are posted within an online system such as an online network and/or online marketplace. The user interfaces include graphical user interfaces (GUIs), web-based user interfaces, and/or other types of interfaces that allow members of the online system to access the content and/or features in the online system from computer systems, mobile devices, gaming consoles, televisions, home assistants, and/or other network-enabled electronic devices.

More specifically, the disclosed embodiments provide a method, apparatus, and system for predicting response rates for interactions in an online system. In these embodiments, response rates include, but are not limited to, response rates of recruiters and/or other job posters to applications for the jobs. In addition, the response rate of a job poster is estimated based on historical applications to jobs from the job poster, as well as various types of historical responses to the historical applications. These historical responses include direct interactions between the job poster and job candidates, as well as notifications to the candidates of the job poster's actions on the candidates' applications. In other words, the historical responses can include any “signals” that are indicative of action on the candidates' job applications by the job poster.

For example, the historical responses include notifications (e.g., emails, messages, alerts, etc.) of the job poster's views of candidates' profiles, after receiving job applications from the candidates. The historical responses also, or instead, include notifications of the job posters' views of the candidates' job applications, rejections of the candidates' job applications, downloads of the candidates' resumes, and/or advancing the candidates along hiring pipelines for the jobs. The historical responses also, or instead, include messages from the job poster to the candidates after receiving job applications from the candidates.

The historical applications and/or responses are also collected based on a time window. For example, historical applications to the job poster's jobs are identified as falling within a 30-day time window that starts 37 days before the current time and ends 7 days before the current time. Historical responses to the historical applications are then identified as responses to the historical applications that can be received up to the current time.

The historical responses are then aggregated into a predicted response rate for the job poster. For example, one or more rules and/or formulas are applied to the metrics related to the historical applications and/or historical responses to estimate the job poster's likelihood of responding to a given job application and/or categorize the job poster's responsiveness to applications. In another example, the metrics and/or other features related to the job poster and a given job and/or candidate are inputted into a machine learning model, and the machine learning model outputs a predicted likelihood of the job poster's response to the candidate's application for the job.

The predicted response rate is also used to generate and/or modulate recommendations related to the candidates and/or jobs. For example, one or more thresholds are applied to the predicted response rate to categorize the job poster's responsiveness (e.g., low, medium, high, very high, etc.) and/or convert the predicted response rate into a different granularity (e.g., converting percentage response rates into 10% increments). The responsiveness and/or converted response rate are outputted with jobs managed by the job poster to encourage candidates to apply to jobs with higher response rates.

In another example, the predicted response rate is inputted with other features into a machine learning model that generates relevance scores between a candidate and a set of jobs, and a ranking of the jobs by descending relevance score is outputted as search results and/or job recommendations to the candidate. As a result, the predicted response rate is used as a factor in selecting and/or ordering jobs in the search results and/or recommendations.

By predicting response rates by posters of jobs (or other opportunities) to applications to the jobs (or other actions) by candidates, the disclosed embodiments allow recommendations and/or insights related to the predicted response rates to be delivered to the candidates. In turn, the overall response rate to the applications and/or the quality of applications are increased, which expedites job seeking by the candidates and/or placement of the jobs by the posters. The increased efficiency and/or effectiveness of the candidates' applications additionally reduces processing and/or storage related to job searches, job applications, and/or other job-related activity, thereby improving the utilization of processor, memory, storage, input/output (I/O), and/or other resources by the online system and/or the performance of applications, services, tools, and/or computer systems used to implement the online system. Consequently, the disclosed embodiments may improve computer systems, applications, user experiences, tools, and/or technologies related to predicting response rates, generating recommendations, employment, recruiting, and/or hiring.

### Response Rate Prediction

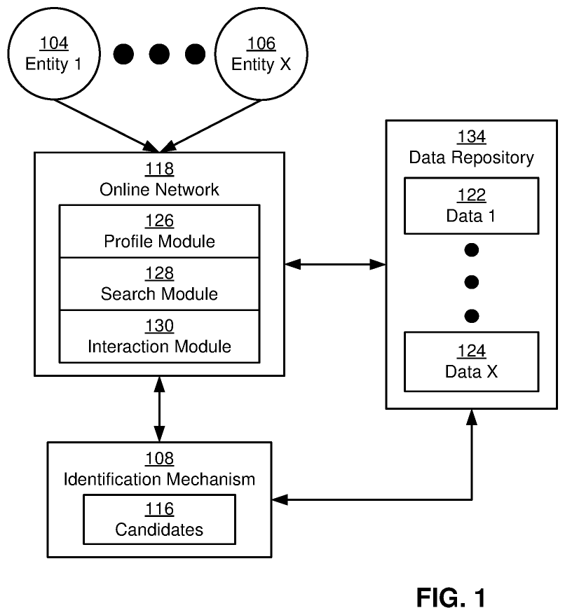

FIG. 1 shows a schematic of a system in accordance with the disclosed embodiments. As shown in FIG. 1, the system includes an online network 118 and/or other user community. For example, online network 118 includes an online professional network that is used by a set of entities (e.g., entity 1 104, entity x 106) to interact with one another in a professional and/or business context.

The entities include users that use online network 118 to establish and maintain professional connections, list work and community experience, endorse and/or recommend one another, search and apply for jobs, and/or perform other actions. The entities also, or instead, include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 also allows the entities to view the profiles of other entities in online network 118.

Profile module 126 also, or instead, includes mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 is logged and stored in a database, data warehouse, cloud storage, and/or other data-storage mechanism providing data repository 134.

Data in data repository 134 is then used to generate recommendations and/or other insights related to listings of jobs or opportunities within online network 118. For example, one or more components of online network 118 may log searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend jobs, advertisements, posts, articles, connections, products, companies, groups, and/or other types of content, entities, or actions to members of online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 are inputted into the machine learning model(s), along with features and/or characteristics of the corresponding opportunities (e.g., required or desired skills, education, experience, industry, title, etc.). The machine learning model(s) then output scores representing the strengths of candidates 116 with respect to the opportunities and/or qualifications related to the opportunities (e.g., skills, current position, previous positions, overall qualifications, etc.). For example, the machine learning model(s) generate scores based on similarities between the candidates' profile data with online network 118 and descriptions of the opportunities. The model(s) further adjust the scores based on social and/or other validation of the candidates' profile data (e.g., endorsements of skills, recommendations, accomplishments, awards, patents, publications, reputation scores, etc.). The rankings are then generated by ordering candidates 116 by descending score.

In turn, rankings based on the scores and/or associated insights improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may output a ranking of candidates for a given set of job qualifications as search results to a recruiter after the recruiter performs a search with the job qualifications included as parameters of the search. In a fourth example, the component(s) may recommend jobs to a candidate based on the predicted relevance or attractiveness of the jobs to the candidate and/or the candidate's likelihood of applying to the jobs.

On the other hand, a large number of applications from candidates 116 may fail to receive responses from hiring managers, recruiters, human resources professionals, and/or other entities involved in posting or placing the opportunities. For example, a large proportion of applications may be received for a relatively small number of opportunities, resulting in a low response rate to the applications. As a result, candidates 116 may expend time and effort on applications that do not result in subsequent interaction or progress in the candidates' job searches, which may be discouraging to candidates 116. At the same time, posters of the opportunities may be barraged with applications, thus precluding meaningful or effective review of the applications.

In one or more embodiments, job searches, job applications, and/or other types of interactions involving members of online network 118 are improved by predicting the rates of response to the applications by the moderators and generating recommendations and/or other output based on the predicted likelihoods. For example, a member may previously spend time and effort applying to an opportunity for which the member is unlikely to receive a response (e.g., because the opportunity is far along in the process and/or the member does not have the relevant qualifications for the opportunity). However, the disclosed embodiments allow the member to focus time and resources on opportunities that are more likely to align with the member's job-seeking goals by providing a predicted rate of response for a given job application. In turn, processing of job searches, job applications, and/or other job-related activity by online network 118 is reduced, thereby improving the utilization of processor, memory, storage, input/output (I/O), and/or other resources by online network 118 and/or the performance of applications, services, tools, and/or computer systems used to implement online network 118.

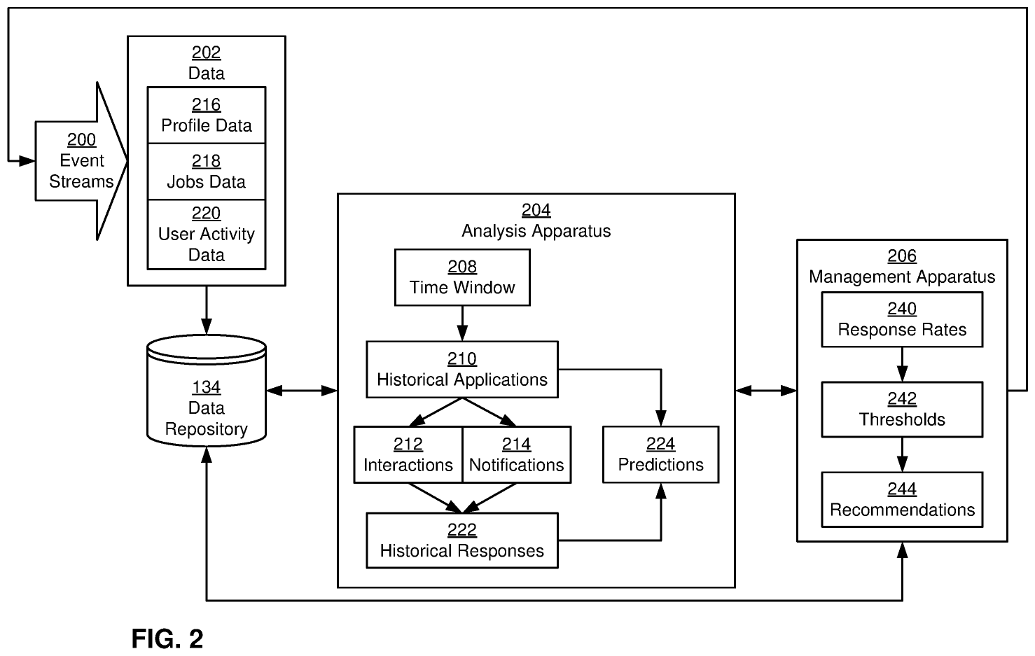

As shown in FIG. 2, data repository 134 and/or another primary data store are queried for data 202 that includes profile data 216 for members of an online system (e.g., online network 118 of FIG. 1), jobs data 218 for jobs that are listed or described within or outside the online system, and/or user activity data 220 that logs the members' activity within and/or outside the online system.

Profile data 216 includes data associated with member profiles in the platform. For example, profile data 216 for an online professional network includes a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 also includes a set of groups to which the user belongs, the user's contacts and/or connections, awards or honors earned by the user, licenses or certifications attained by the user, patents or publications associated with the user, and/or other data related to the user's interaction with the platform.

Attributes of the members are optionally matched to a number of member segments, with each member segment containing a group of members that share one or more common attributes. For example, member segments in the platform may be defined to include members with the same industry, title, location, and/or language.

Connection information in profile data 216 is optionally combined into a graph, with nodes in the graph representing entities (e.g., users, schools, companies, locations, etc.) in the platform. Edges between the nodes in the graph represent relationships between the corresponding entities, such as connections between pairs of members, education of members at schools, employment of members at companies, following of a member or company by another member, business relationships and/or partnerships between organizations, and/or residence of members at locations.

Jobs data 218 includes structured and/or unstructured data for job listings and/or job descriptions that are posted or provided by members of the online system. For example, jobs data 218 for a given job or job listing include a declared or inferred title, company, required or desired skills, responsibilities, qualifications, role, location, industry, seniority, salary range, benefits, and/or member segment.

User activity data 220 includes records of user interactions with one another and/or content associated with the platform. For example, user activity data 220 logs impressions, clicks, likes, dislikes, shares, hides, comments, posts, updates, conversions, and/or other user interaction with content in the platform. User activity data 220 also, or instead, logs other types of activity, including connections, messages, job applications, job searches, recruiter searches for candidates, interaction between candidates 116 and recruiters, and/or interaction with groups or events. In some embodiments, user activity data 220 further includes social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 220 additionally includes schedules, calendars, and/or upcoming availabilities of the users, which may be used to schedule meetings, interviews, and/or events for the users. Like profile data 216, user activity data 220 is optionally used to create a graph, with nodes in the graph representing members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

In one or more embodiments, profile data 216, jobs data 218, user activity data 220, and/or other data 202 in data repository 134 is standardized before the data is used by components of the system. For example, skills in profile data 216 and/or jobs data 218 are organized into a hierarchical taxonomy that is stored in data repository 134 and/or another repository. The taxonomy models relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 include cities, metropolitan areas, states, countries, continents, and/or other standardized geographical regions. Like standardized skills, the locations can be organized into a hierarchical taxonomy (e.g., cities are organized under states, which are organized under countries, which are organized under continents, etc.).

In a third example, data repository 134 includes standardized company names for a set of known and/or verified companies associated with the members and/or jobs. In a fourth example, data repository 134 includes standardized titles, seniorities, and/or industries for various jobs, members, and/or companies in the online system. In a fifth example, data repository 134 includes standardized time periods (e.g., daily, weekly, monthly, quarterly, yearly, etc.) that can be used to retrieve profile data 216, jobs data 218, user activity data 220, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

In some embodiments, standardized attributes in data repository 134 are represented by unique identifiers (IDs) in the corresponding taxonomies. For example, each standardized skill is represented by a numeric skill ID in data repository 134, each standardized title is represented by a numeric title ID in data repository 134, each standardized location is represented by a numeric location ID in data repository 134, and/or each standardized company name (e.g., for companies that exceed a certain size and/or level of exposure in the online system) is represented by a numeric company ID in data repository 134.

Data 202 in data repository 134 can be updated using records of recent activity received over one or more event streams 200. For example, event streams 200 are generated and/or maintained using a distributed streaming platform. One or more event streams 200 are also, or instead, provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the platform is generated in response to the activity. The record is then propagated to components subscribing to event streams 200 on a nearline basis.

An analysis apparatus 204 generates predictions 224 of response rates 240 by posters of jobs (or other opportunities) to applications for the jobs (or other activity performed by members with respect to the opportunities). For example, each prediction generated by analysis apparatus 204 represents the likelihood that a candidate that submits an application to a job receives a response to the application.

As shown in FIG. 2, predictions 224 are based on numbers and/or attributes of historical applications 210 by the candidates to the jobs, as well as numbers and/or attributes of historical responses 222 to historical applications 222. First, analysis apparatus 204 identifies, for each poster, historical applications 210 to the poster's jobs within a time window 208. For example, analysis apparatus 204 queries data repository 134 and/or another data store for historical applications 222 to the poster's jobs within a time window 208 that spans a period of 30 days before the current time or date.

In one or more embodiments, historical applications 222 include applications that are hosted onsite within the online system (e.g., in a jobs module or feature), as well as clicks to applications that are hosted offsite (e.g., on a “careers” page of a company's external website). As a result, analysis apparatus 204 determines the number of historical applications 222 within time window 208 as a sum and/or another aggregation of the number of onsite applications to the poster's jobs with the number of clicks to offsite applications for the poster's jobs.

Next, analysis apparatus 204 identifies historical responses 222 to historical applications 210 that fall within time window 208. For example, analysis apparatus 204 queries data repository 134 and/or another data store for historical responses 222 associated with identifiers of historical applications 210 that were submitted within the 30-day time window 208.

To allow responses to be generated for applications that were received near the end of time window 208, analysis apparatus 204 configures time window 208 to end at a pre-specified interval before the current time. For example, analysis apparatus 204 sets time window 208 to start 37 days before the current date and end 7 days before the current date. As a result, analysis apparatus 204 can collect historical responses 222 up to a week after the end of time window 208, which significantly increases the coverage of responses to applications received near the end of time window 208 (e.g., based on analysis of job-related activity, which indicates that most responses are received within a week of the corresponding applications).

In one or more embodiments, historical responses 222 include various “signals” that indicate action taken by the poster in response to historical applications 210 to the poster's jobs. More specifically, historical responses 222 include interactions 212 of the poster with candidates that submitted historical applications 210, as well as notifications 214 of any actions related to historical applications 210 performed by the poster.

Interactions 212 include communications transmitted from the poster to a given candidate, after the candidate applies to the poster's job. For example, interactions 212 include messages, emails, chats, phone calls, and/or other types of communication between the poster and candidate that can be logged and/or detected by the online system.

Notifications 214 include communications transmitted from the online system to the candidate that relate updates to the poster's actions on the candidate's application. For example, notifications 214 include emails, alerts, chats, messages, and/or other types of communication that are generated by the online system after the poster performs certain types of actions related to the candidate's application. The actions include, but are not limited to, viewing the candidate's profile, viewing the candidate's application, rejecting the candidate's application, downloading the candidate's resume, and/or marking the candidate as a good fit for an opportunity to which the candidate applied. The actions also, or instead, include advancing the candidate along a hiring pipeline for the opportunity, which can include moving the candidate to a stage of the hiring pipeline that indicates contact with the candidate, response to the contact by the candidate, assessment of the candidate's skills or qualifications, phone screening of the candidate, interviewing of the candidate, a background check for the candidate, and/or hiring of the candidate.

In one or more embodiments, analysis apparatus 204 determines the number of historical applications 210 for which historical responses 222 have been received based on associations between historical applications 210 and historical responses 222. For example, analysis apparatus 204 joins records of historical responses 222 with records of historical applications 210 by job, candidate, and/or application identifiers in the records to identify a subset of historical applications 210 for which historical responses 222 have been received.

On the other hand, certain actions performed by the poster may result in notifications 214 that do not count as historical responses 222 to historical applications 210 by candidates. For example, candidates that applied to the poster's jobs are unable to receive explicit notifications 214 of profile views from the poster when the poster has profile viewing settings that anonymize the poster's identity in profile view notifications 214. To ensure that historical responses 222 are counted correctly, analysis apparatus 204 excludes these notifications 214 from historical responses 222.

Along the same lines, some types of historical responses 222 may lack explicit associations with the corresponding historical applications 210. For example, records of the poster's profile views may lack associations with jobs or applications to the jobs (e.g., because profile views in the online system are not necessarily specific to candidates or applications for jobs). As a result, analysis apparatus 204 generates associations between these types of historical responses 222 and historical applications 210 based on attributes that are common to historical responses 222 and historical applications 210. Continuing with the above example, analysis apparatus 204 obtains a viewee identifier from a record of a profile view by the poster and matches the viewee identifier to a candidate identifier in records of one or more applications to the poster's jobs. Analysis apparatus 204 then associates the profile view with any applications containing the candidate identifier that were received before the profile view.

Analysis apparatus 204 then generates predictions 224 of responses rates 240 for job posters based on metrics and/or attributes associated with historical applications 210 and historical responses 222. In one or more embodiments, the metrics and/or attributes include a first number of historical applications 210 received within time window 208 and a second number of historical applications 210 for which historical responses 222 were subsequently generated. For example, analysis apparatus 204 predicts a response rate for a poster by dividing the second number by the first number.

Analysis apparatus 204 also, or instead, customizes prediction of the poster's response rate for a particular candidate and/or job. For example, analysis apparatus 204 inputs the first and second numbers of historical applications 210, along with additional features that characterize the candidate and/or job, into a machine learning model. The additional features include, but are not limited to, a submission number of the candidate's potential or existing application for an opportunity (i.e., the ordinal position of the application in a series of applications for the same opportunity that are ordered by time of submission). The additional features also, or instead, include a match score between the candidate and the job, which can be calculated based on overlap or commonality between the candidate's attributes in profile data 216 and the corresponding attributes in jobs data 218 for the job (e.g., similarity in country, seniority, industry, and/or function between the candidate and job). The additional features also, or instead, include the amount of time the job has been posted. The additional features also, or instead, include the source of the application (e.g., onsite, offsite, etc.). After the features are inputted into the machine learning model, the machine learning outputs a score ranging from 0 to 1 representing a predicted likelihood of response to the candidate's application to the job.

Analysis apparatus 204 also, or instead, predicts response rates 240 by modeling the distribution of likelihoods of response for a given poster and/or group of posters (e.g., a recruiting team at a company). For example, the distribution can be modeled using a Beta distribution with parameters α and β:

X˜Beta(α,β)

The probability density function (pdf) of the Beta distribution, for 0≤x≤1 and shape parameters α, β>0, is a power function of the variable x and its reflection (1−x):

f(x;α,β)=constant·x^{α-1}(1−x)^{β-1}

The expected value of the random variable X is a function of the ratio of the two parameters:

E[X]=α/(α+β)

Continuing with the above example, the distribution can be customized to the response behavior of an individual job poster using the following representation:

Xᵢ˜Beta(αᵢ+Responseᵢ,βᵢ+NoResponseᵢ)

In the above representation, Xᵢ represents the distribution of response rates 240 for job poster i, which is modeled using parameters αᵢ and βᵢ that are specific to the job poster. When the job poster generates a response to a job application, αᵢ is increased by 1 (or another value representing the response). When the job poster fails to generate a response to a job application (e.g., after a 30-day period for responding to the application), βᵢ is increased by 1 (or another value representing the lack of response). As a result, the predicted response rate of the job poster for a given application can be estimated using the mean of customized distribution:

E[Xᵢ]=(αᵢ+Responseᵢ)/(αᵢ+Responseᵢ+βᵢ+NoResponseᵢ)

Continuing with the above example, the distribution can be initialized for a new job poster j that lacks historical response data by aggregating αᵢ and βᵢ for all job posters in the online system and/or all job posters in the same segment as the new job poster. Thus, αⱼ is initialized to the average historical response rate of the job posters, and βⱼ is initialized to the average historical non-response rate of the job posters.

Continuing with the above example, a confidence interval for the predicted response rate can be estimated from the cumulative distribution function of the Beta distribution:

y=F(x;α,β)

More specifically, the estimated response rate is no less than x with a confidence of y.

Continuing with the above example, a decay factor can be added to the prediction to account for the number of applications that the job poster has already received:

p(x;α,β,n)=F(x;α,β)*decay(n)

In the above equation, n represents the number of applications received for a given job, and decay represents an exponential (or other type) of decay that is applied to n. As a result, decay(n) models the decrease in response rate that occurs as the number of applications increases.

In some embodiments, analysis apparatus 204 executes on an offline, periodic, or batch-processing basis to produce predictions 224 of responses rates 240 related to a large number of posters, jobs, applications, and/or candidates. Analysis apparatus 204 also, or instead, generates predictions 224 in an on an online, nearline, and/or on-demand basis based on recent job-seeking behavior by the candidates (e.g., user sessions with the online system, job searches, job views, job clicks, job applications, etc.). After predictions 224 of response rates 240 are generated, analysis apparatus 204 stores response rates 240 in data repository 134 for subsequent retrieval and use. Analysis apparatus 204 also, or instead, provides response rates 240 to a management apparatus 206 and/or another component of the system to allow the component to perform additional tasks using response rates 240.

More specifically, management apparatus 206 uses responses rates 240 predicted by analysis apparatus 204 to generate recommendations 244 and/or other output related to the corresponding posters, candidates, and/or jobs. In one or more embodiments, management apparatus 206 determines recommendations 244 based on one or more thresholds 242 for response rates 240. For example, management apparatus 206 sets a threshold for response rates 240 to a pre-specified value (e.g., 0.5), a multiple (e.g., 2-3×) of the average response rate for all posters, a percentile associated with the distribution of response rates 240, and/or another value. When a given response rate exceeds the threshold, management apparatus 206 outputs a notification, communication, and/or other indication to each candidate to which the response rate pertains that the candidate has a high likelihood of receiving a response if the candidate applies to a job by the poster to which the response rate pertains (e.g., “This job poster has responded to more than 50% of applications in the last 30 days”).

In another example, management apparatus 206 uses multiple thresholds 242 representing 10% increments in response rates 240 to convert a predicted response rate of 63% into a lower-granularity response rate of greater than 60%. Management apparatus 206 then outputs a recommendation of “This job poster has responded to more than 60% of applications in the last 30 days” to all jobs to which the response rate applies.

In a third example, management apparatus 206 inputs predicted response rates 240 with other features into a machine learning model that generates relevance scores between a candidate and a set of jobs. Management apparatus 206 then ranks the jobs by descending relevance score and outputs a highest-ranked subset of the jobs as job recommendations 244 and/or job search results to the candidate. As a result, response rates 240 are used as a factor in ranking and/or delivering jobs to candidates.

Management apparatus 206 and/or another component additionally log the candidates' responses to recommendations 244 and/or applications to jobs, as well as subsequent responses to the applications by posters of the jobs. The logged activity is propagated in event streams 200 to data repository 134 and subsequently used by analysis apparatus 204 to update predictions 224 of response rates 240. As a result, the system generates response rates 240, thresholds 242, and/or recommendations 244 based on recent and/or up-to-date activity by the candidates and posters.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of techniques may be used to generate response rates 240. For example, response rates 240 may be predicted using a set of rules, a formula, and/or a machine learning model such as a regression model, artificial neural network, support vector machine, decision tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features and outcomes used to train the machine learning model. Multiple versions of a machine learning model may further be adapted to different subsets of candidates, posters, and/or jobs (e.g., different member segments in the community), or the same machine learning model may be used to generate response rates 240 for all candidates, jobs, and/or posters in the online system.

Third, the system of FIG. 2 may be adapted to predict response rates 240 and/or make recommendations 244 for various types of opportunities. For example, the functionality of the system may be used to improve response rates 240 and/or applications related to academic positions, artistic or musical roles, school admissions, fellowships, scholarships, competitions, club or group memberships, matchmaking, and/or other types of opportunities.

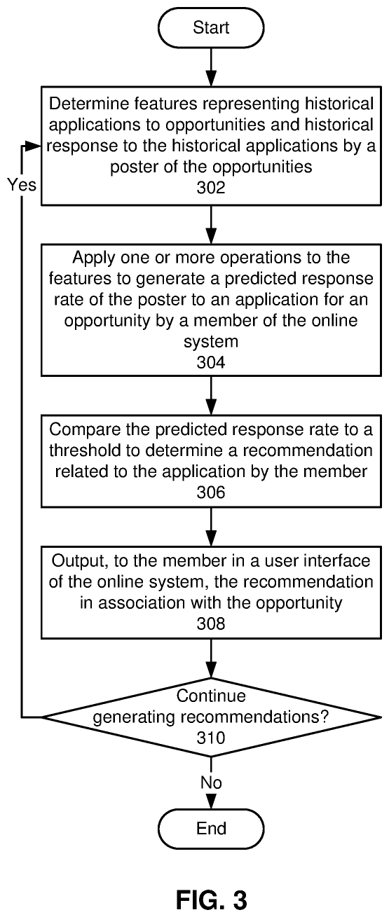

FIG. 3 shows a flowchart illustrating a process of predicting response rates in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, features representing historical applications to opportunities and historical responses to the historical applications by a poster of the opportunities are determined (operation 302). For example, the features are obtained and/or generated from events and/or records of the historical applications and historical responses in a data store, such as data repository 134 of FIG. 1.

The features include a first number of historical applications received within a time window, as well as a second number of historical applications for which historical responses were received. The first number can be determined by aggregating clicks on offsite applications to the opportunities within the time window with onsite applications to the opportunities within the time window. The second number is determined based on explicit associations between the historical applications and historical responses. The second number is also, or instead, determined by identifying an action by the poster that results in a notification to a candidate (e.g., viewing of the candidate's profile by the poster) and adding any applications submitted by the candidate to the poster's opportunities before the action to the second number.

Next, one or more operations are applied to the features to generate a predicted response rate of the poster to an application for an opportunity by a member of the online system (operation 304). For example, dividing the second number of historical applications for which responses were generated is divided by the first number of historical applications received within the time window to produce the predicted response rate. In another example, the first and/or second numbers and/or predicted response rate are inputted with additional features related to the member and the opportunity into a machine learning model, and a predicted response rate that is customized to the member and/or opportunity is obtained as output of the machine learning model. In a third example, the poster's predicted response rate is calculated as the mean of a Beta distribution with parameters that reflect the poster's historical responses and lack of responses to the historical applications.

The predicted response rate is then compared to a threshold to determine a recommendation related to the application by the member (operation 306), and the recommendation is outputted in association with the opportunity to the member in a user interface of the online system (operation 308). For example, the threshold may be set to a numeric value for the predicted response rate, a percentage or multiple over an average response rate, a quantile associated with the distribution of response rates for a set of posters, and/or another value. The threshold may also be selected based on the industry, location, company, seniority, title, role, position, and/or other attribute associated with the application or member. When the predicted response rate exceeds the threshold, a recommendation that includes the predicted response rate, encourages the member to apply to the opportunity, and/or increases the opportunity's position in a ranking of opportunities for the member is generated.

Operations 302-308 may be repeated while recommendations are generated (operation 310) based on predicted response rates of posters to applications. For example, recommendations may continue to be made to improve user experiences associated with applying to and/or reviewing applications for the opportunities. To continue generating recommendations, features representing historical applications to opportunities and historical responses to the applications are determined (operation 302) and used to predict response rates of posters of the opportunities (operation 304). The predicted response rates are then compared with one or more thresholds to generate and output recommendations related to the applications and opportunities (operations 306-308) to members of the online system. Such prediction of response rates and generation of recommendations may continue until response rates are no longer used to modulate interaction between candidates applying to opportunities and posters of the opportunities.

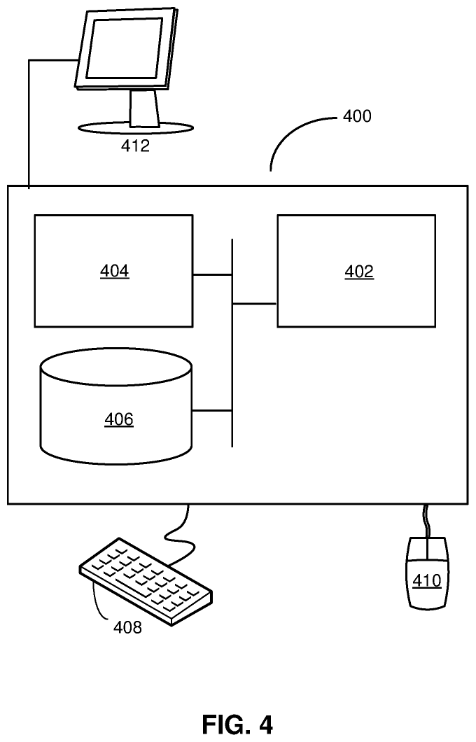

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for predicting response rates. The system includes an analysis apparatus and a management apparatus, one or more of which may alternatively be termed or implemented as a module, mechanism, or other type of system component. The analysis apparatus determines features representing historical applications to opportunities and historical responses to the historical applications by a poster of the opportunities. The historical responses include interactions between the poster and candidates submitting the historical applications and notifications transmitted to the candidates of actions related to the historical applications by the poster. Next, the analysis apparatus applies one or more operations to the features to generate a predicted response rate of the poster to an application for an opportunity by a member of the online system. The management apparatus then compares the predicted response rate to a threshold to determine a recommendation related to the application by the member. Finally, the management apparatus outputs, to the member in a user interface of the online system, the recommendation in association with the opportunity.

In addition, one or more components of computer system 400 may be remotely located and connected to the other components over a network. Portions of the present embodiments (e.g., analysis apparatus, management apparatus, data repository, online network, etc.) may also be located on different nodes of a distributed system that implements the embodiments. For example, the present embodiments may be implemented using a cloud computing system that predicts response rates and generates recommendations related to a set of remote members of an online system.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
determining, based on data retrieved from a data store in an online system, features representing historical applications to opportunities and historical responses to the historical applications by a poster of the opportunities, wherein the historical responses comprise interactions between the poster and candidates submitting the historical applications and notifications transmitted to the candidates of actions related to the historical applications by the poster;
applying, by one or more computer systems, one or more operations to the features to generate a predicted response rate of the poster to an application for a first opportunity by a member of the online system;
comparing, by the one or more computer systems, the predicted response rate to a threshold to determine a recommendation related to the application by the member; and
outputting, to the member in a user interface of the online system, the recommendation in association with the first opportunity.

2. The method of claim 1, wherein determining the features representing the historical applications to the opportunities and the historical responses to the historical applications by the poster comprises:
identifying a first number of the historical applications received within a time window; and
determining, out of the first number of the historical applications, a second number of the historical applications for which the historical responses were generated.

3. The method of claim 2, wherein applying the one or more operations to the features to generate the predicted response rate of the poster comprises:
dividing the second number of the historical applications by the first number of the historical applications to produce the predicted response rate.

4. The method of claim 2, wherein applying the one or more operations to the features to generate the predicted response rate of the poster comprises:
inputting the first number of the historical applications, the second number of the historical applications, and additional features related to the member and the first opportunity into a machine learning model; and
obtaining the predicted response rate as output of the machine learning model.

5. The method of claim 2, wherein identifying the first number of the historical applications received over the time window comprises:
aggregating clicks on offsite applications to the opportunities with onsite applications to the opportunities into the first number of the historical applications.

6. The method of claim 2, wherein determining the second number of the historical applications for which the historical responses were generated comprises:
identifying, in the historical responses, an action by the poster that results in a notification to a candidate; and
adding one or more applications submitted by the candidate to one or more of the opportunities before the action including to the second number of the historical applications.

7. The method of claim 2, wherein an end of the time window precedes a current time by a pre-specified interval.

8. The method of claim 1, wherein the interactions between the poster and the candidates comprise messages from the poster to the candidates.

9. The method of claim 1, wherein the actions related to the historical applications by the poster comprise at least one of:
a profile view;
an application view;
an application rejection;
a resume download;
marking a candidate as a good fit for a second opportunity; and
advancing the candidate along a hiring pipeline.

10. The method of claim 1, wherein the threshold comprises a minimum response rate.

11. The method of claim 1, wherein the recommendation comprises an indication of a high predicted response rate by the poster to the application.

12. A system, comprising:
one or more processors; and
memory storing instructions that, when executed by the one or more processors, cause the system to:
determine, based on data retrieved from a data store in an online system, features representing historical applications to opportunities and historical responses to the historical applications by a poster of the opportunities, wherein the historical responses comprise interactions between the poster and candidates submitting the historical applications and notifications transmitted to the candidates of actions related to the historical applications by the poster;
apply one or more operations to the features to generate a predicted response rate of the poster to an application for a first opportunity by a member of the online system;
compare the predicted response rate to a threshold to determine a recommendation related to the application by the member; and
output, to the member in a user interface of the online system, the recommendation in association with the first opportunity.

13. The system of claim 12, wherein determining the features representing the historical applications to the opportunities and the historical responses to the historical applications by the poster comprises:
identifying a first number of the historical applications received within a time window; and
determining, out of the first number of the historical applications, a second number of the historical applications for which the historical responses were generated.

14. The system of claim 13, wherein applying the one or more operations to the features to generate the predicted response rate of the poster comprises:
dividing the second number of the historical applications by the first number of the historical applications to produce the predicted response rate.

15. The system of claim 13, wherein identifying the first number of the historical applications received over the time window comprises:
aggregating clicks on offsite applications to the opportunities with onsite applications to the opportunities into the first number of the historical applications.

16. The system of claim 13, wherein determining the second number of the historical applications for which the historical responses were generated comprises:
identifying, in the historical responses, an action by the poster that results in a notification to a candidate; and
adding one or more applications submitted by the candidate to one or more of the opportunities before the action including to the second number of the historical applications.

17. The system of claim 16, wherein the action comprises a profile view.

18. The system of claim 12, wherein applying the one or more operations to the features to generate the predicted response rate of the poster comprises:
inputting metrics related to the historical applications and the historical responses and additional features related to the member and the first opportunity into a machine learning model; and
obtaining the predicted response rate as output of the machine learning model.

19. The system of claim 12, wherein an end of the time window precedes a current time by a pre-specified interval.

20. A non-transitory computer-readable storage medium storing instructions that when executed by a computer cause the computer to perform a method, the method comprising:
determining, based on data retrieved from a data store in an online system, features representing historical applications to opportunities and historical responses to the historical applications by a poster of the opportunities, wherein the historical responses comprise interactions between the poster and candidates submitting the historical applications and notifications transmitted to the candidates of actions related to the historical applications by the poster;
applying one or more operations to the features to generate a predicted response rate of the poster to an application for a first opportunity by a member of the online system;
comparing the predicted response rate to a threshold to determine a recommendation related to the application by the member; and
outputting, to the member in a user interface of the online system, the recommendation in association with the first opportunity.
